(19) United States
(12) Patent Application Publication
(10) Pub. No.: US 2004/0176532 A1
(43) Pub. Date: Sep. 9, 2004

(54) Method for improved production of graft polymers

(76) Inventors: Vera Buchholz, Koln (DE); Eckhard Wenz, Koln (DE); Herbert Eichenauer, Dormagen (DE); Ralf-Jurgen Born, Ingelheim (DE); Christian Lange, Soest (DE); Sven Hobeika, Solingen (DE)

Correspondence Address: BAYER POLYMERS LLC, 100 BAYER ROAD, PITTSBURGH, PA, 15205, US

(21) Appl. No.: 10/771,656

(22) Filed: Feb. 4, 2004

(30) Foreign Application Priority Data
Feb. 6, 2003 (DE) 10304817.0

(51) Int. Cl. C08K 3/00

(52) U.S. Cl. 524/800

(57) ABSTRACT

A process of producing a graft polymer of the ABS type by the emulsion method is disclosed. In the process wherein 5 to 95% by weight of a monomer mixture that contains A) 50 to 99 parts by weight of at least one vinyl aromatic compound and B) 1 to 50 parts by weight of at least one copolymer is polymerized in the presence of C) 95 to 5% by weight of one or more graft substrates having a glass transition temperature <10° C., the improvement includes monitoring continuously in the course of the reaction the Raman spectra of the reaction mixture, determining deviations from the specified desired course of the reaction and making corresponding adjustments.

### FIELD OF THE INVENTION

The invention relates to graft polymers and more particularly to a process for their preparation.

### SUMMARY OF THE INVENTION

A process of producing a graft polymer of the ABS type by the emulsion method is disclosed. In the process wherein 5 to 95% by weight of a monomer mixture that contains A) 50 to 99 parts by weight of at least one vinyl aromatic compound and B) 1 to 50 parts by weight of at least one copolymer is polymerized in the presence of C) 95 to 5% by weight of one or more graft substrates having a glass transition temperature <10° C., the improvement includes monitoring continuously in the course of the reaction the Raman spectra of the reaction mixture, determining deviations from the specified desired course of the reaction and making corresponding adjustments.

### BACKGROUND OF THE INVENTION

Graft polymers of the ABS type are two-phase plastics materials made of a thermoplastic copolymer of resin-forming monomers, for example, styrene and acrylonitrile, and at least one graft polymer, which is obtainable by polymerization of one or more resin-forming monomers, for example, the above-mentioned monomers, in the presence of rubber, for example, butadiene homopolymer or copolymer as the graft substrate.

The term graft polymers of the ABS type in the present context includes compositions of the type in which these constituents are completely or partially replaced by analogous constituents.

Examples of analogous constituents for styrene are, for example, α-methyl styrene, chlorostyrene, vinyl toluene, p-methyl styrene or tert.-butyl styrene. Examples of analogous constituents for acrylonitrile are, for example, methacrylonitrile, ethacrylonitrile, methyl methacrylate or N-phenylmaleinimide. A similar constituent for butadiene is, for example, isoprene.

Graft polymers of the ABS type and methods for their production are known in principle (see, for example, Ullmann's Encyclopaedia of Industrial Chemistry, Vol. A21, VCH Weinheim, 1992). These graft polymers may be produced, for example, by polymerization in solution or by the so-called mass method and by polymerization in the presence of water (emulsion polymerization, suspension polymerization).

In the methods known from the prior art, attempts are generally made to achieve a course of the reaction which is as uniform as possible with as many process parameters as possible (such as, for example, temperature, monomer supply profile, pressure etc.) being kept as constant as possible, and thereby to obtain products with advantageous properties which are as reproducible as possible.

On an industrial scale, however, maintaining the process parameters is no guarantee of the absolute reproducibility of the method and of obtaining products with specified properties. The reaction rate profile can be influenced by many factors, such as, for example, impurities contained in the reactants, variations in the stirring speed, in the surface condition of the reaction vessel, variations in the particle size etc.

These causes can lead both to depletion and also to enrichment of the reaction mixture in one or more monomers during graft polymerization.

Apart from reductions in the product quality, a deviation of this type in the concentration of one or more monomers from the conventional concentration at a given point in time can, however, also lead to problems from safety aspects (for example risk of an uncontrolled course of the reaction such as, for example, “passing through” of the reaction).

### DESCRIPTION OF THE FIGURES

FIG. 1 shows the course of the reaction, detected by Raman Spectroscopy, described in Example 1.

FIG. 2 shows the course of the reaction, detected by Raman Spectroscopy, described in Example 2.

FIG. 3 shows the course of the reaction, detected by Raman Spectroscopy, described in Example 3.

FIG. 4 shows the morphology of the product of Example 1.

FIG. 5 shows the morphology of the product of Example 2.

FIG. 6 shows the morphology of the product of Example 3.

### DETAILED DESCRIPTION OF THE INVENTION

The subject of the present invention is a method for improved production of graft polymers of the ABS type by the emulsion method, wherein

5 to 95, preferably 30 to 90 percent by weight of a monomer mixture containing

A) 50 to 99% by weight, preferably 50 to 70% by weight of at least one vinyl aromatic monomer and

B) 1 to 50% by weight, preferably 30 to 50% by weight of at least one other monomer the % being relative to the total weight of (A) and (B),

are polymerized in the presence of

C) 95 to 5, preferably 70 to 10 percent by weight of one or more rubber graft substrate with glass transition temperatures of <10° C., preferably <0° C., particularly preferably <−20° C.

the percents being relative to the total weight of the mixture and (C), characterized in that the course of the reaction is continuously monitored by the recording of Raman spectra of the reaction mixture and corrective measures are introduced in the event of deviations from the desired monomer concentrations.

Corrective measures may include, for example, increasing or decreasing the feed rate of one or all monomers and/or the initiator

Suitable vinyl aromatic compounds A) are, for example, styrene, α-methyl styrene and vinyl aromatic compounds substituted in the nucleus such as, for example, p-methyl styrene and p-chlorostyrene and mixtures of these monomers.

Suitable comonomers B) are, for example, vinyl cyanides (unsaturated nitriles) such as acryloritrile and methacrylonitrile and/or (meth)acrylic acid-(C₁-C₈)-alkyl ester (such as methyl methacrylate, n-butyl acrylate, t-butyl acrylate) and/or derivatives (such as anhydrides and imides) of unsaturated carboxylic acids (for example maleic anhydride and N-phenylmaleinimide).

Preferred monomer A) is at least one member selected from the group consisting of styrene and α-methyl styrene, preferred monomer B) is at least one member selected from the group consisting of acrylonitrile, N-phenylmaleinimide and methyl methacrylate.

Particularly preferred monomer A) is styrene and the preferred B) is acrylonitrile.

Preferred graft substrates C) include diene rubbers EP(D)M rubbers, in other words those based on ethylene/propylene and optionally diene, acrylate, polyurethane, silicone, chloroprene and ethylene/vinyl acetate rubbers and mixtures thereof.

Suitable acrylate rubbers are preferably polymers made of acrylic acid alkyl esters, optionally with up to 40% by weight, based on C) of other polymerizable, ethylenically unsaturated monomers. Preferred polymerizable acrylic acid esters include C₁-C₈-alkyl esters, for example, methyl, ethyl, butyl, n-octyl and 2-ethylhexyl ester; haloalkyl esters, preferably halogen-C₁-C₈-alkyl esters, such as chloroethyl acrylate and mixtures of these monomers.

Preferred further polymerizable, ethylenically unsaturated monomers which, apart from the acrylic acid esters, may optionally serve to produce the graft substrate C) are, for example, acrylonitrile, styrene, α-methyl styrene, acrylamides, vinyl-C₁-C₆-alkyl ethers, methyl methacrylate, butadiene. Preferred rubbers as the graft substrate C are emulsion polymers which have a gel content of at least 30% by weight.

Monomers with more than one polymerizable double bond may be copolymerized in the production of acrylate rubbers. Preferred examples of crosslinking monomers are esters of unsaturated monocarboxylic acids with 3 to 8 carbon atoms and unsaturated monovalent alcohols with 3 to 12 carbon atoms, or unsaturated polyols with 2 to 4 OH groups and 2 to 20 carbon atoms such as ethylene glycol dimethacrylate, allyl methacrylate; heterocyclic compounds having a plurality of unsaturations, such as trivinyl and triallyl cyanurate; polyfunctional vinyl compounds, such as divinyl and trivinyl benzenes; but also triallyl phosphate and diallyl phthalate.

Preferred crosslinking monomers are allyl methacrylate, ethylene glycol dimethacrylate, diallyl phthalate and heterocyclic compounds which have at least three ethylenically unsaturated groups.

Particularly preferred crosslinking monomers are the cyclic monomers triallyl cyanurate, triallyl isocyanurate, triacryloylhexahydro-s-triazine, triallyl benzenes. The quantity of the crosslinking monomers is preferably 0.02 to 5, in particular 0.05 to 2% by weight, based on the graft substrate C.

In cyclic crosslinking monomers with at least three ethylenically unsaturated groups, it is advantageous to limit the quantity to below 1% by weight of the graft substrate C.

Further suitable graft substrates according to C) are silicone rubbers with graft-active points, such as are described in DE-A 37 04 657, DE-A 37 04 655, DE-A 36 31 540 and DE-A 36 31 539.

Preferred graft substrates C) are diene rubbers (for example based on butadiene, isoprene etc.) or mixtures of diene rubbers or copolymers of diene rubbers or mixtures thereof with further copolymerizable monomers (for example such as are included in A and B), with the proviso, that the glass transition temperature for component C is below 10° C., preferably <0° C., particularly preferably <−100° C.

Particularly preferred as graft substrate C) is pure polybutadiene rubber.

The gel content of the graft substrate C) is at least 30% by weight, preferably at least 40% by weight. The gel content of the graft substrate C) is determined at 25° C. in toluene (M. Hoffmann, H. Krömer, R. Kuhn, Polymeranalytik I und II, Georg Thieme-Verlag, Stuttgart 1977).

The graft substrate C generally has a median particle size (d₅₀ value) of 0.05 to 10 μm, preferably 0.1 to 5 μm, particularly preferably 0.2 to 1 μm.

The median particle size d₅₀ is the diameter, above and below which 50% by weight of the particles lie, in each case. It can be determined by means of ultracentrifuge measurement (W. Scholtan, H. Lange, Kolloid, Z. und Z. Polymere 250 (1972), 782-796).

The graft polymers are produced by radical emulsion polymerization.

Graft polymerization may be carried out by any addition method. It is preferably carried out such that the monomer mixture containing A) and B) is continuously added to the graft substrate C) and polymerized.

Specific monomer/rubber ratios are preferably maintained. When the method for producing graft polymers is carried out according to the invention, the monomers may be added uniformly to the rubber latex over a defined time period or using any metering gradients, for example, in such a way that within the first half of the total monitoring adding time, 55 to 90% by weight, preferably 60 to 80% by weight and particularly preferably 65 to 75% by weight of the total monomers to be used in the graft polymerization are added; the remaining monomer portion is added within the second half of the total monomer adding time.

Conventional anionic emulsifiers may be used as emulsifiers, such as alkyl sulphates, alkyl sulphonates, aralkyl sulphonates, soaps of saturated or unsaturated fatty acids and alkaline, disproportionate or hydrogenated abietic or tall oil acids. Emulsifiers with carboxyl groups can theoretically also be used (for example salts of C₁₀-C₁₈-fatty acids, disproportionate abietic acid and emulsifiers according to DE-A 36 39 904 and DE-A 39 13 509).

In addition, molecular weight regulators may be used in the graft polymerization, preferably in quantities from 0.01 to 2% by weight, particularly preferably in quantities from 0.05 to 1% by weight (based on the total monomer quantity, in each case). Suitable molecular weight regulators are, for example, alkyl mercaptans such as n-dodecylmercaptan, t-dodecyl-mercaptan; dimeric α-methyl styrene; terpinols.

Possible initiators are inorganic and organic peroxides, for example, H₂O₂, di-tert.-butyl peroxide, cumolhydroperoxide, dicyclohexyl percarbonate, tert.-butyl hydroperoxide, p-menthane hydroperoxide, azoinitiators such as azobisiso-butyronitrile, inorganic persalts such as ammonium, sodium or potassium persulphate, potassium perphosphate, sodium perborate and redox systems.

Redox systems generally include an organic oxidising agent and a reducing agent, wherein heavy metal ions may additionally be present in the reaction medium (see Houben-Weyl, Methoden der Organischen Chemie, Vol. 14/1, page 263 to 297).

The polymerization temperature is generally between 25° C. and 160° C., preferably between 40° C. and 90° C.

The work can then take place with conventional temperature control, for example, isothermally; the graft polymerization is preferably carried out in such a way, however, that the temperature difference between the beginning and the end of the reaction is at least 10° C., preferably at least 15° C. and particularly preferably at least 20° C.

Particularly preferred graft copolymers obtained by the method according to the invention are ABS, as described, for example, in DE-A 20 35 390 (=U.S. Pat. No. 3,644,574) or in DE-A 22 48 242 (=GB-A 1 409 275) or in Ullmanns Enzyklopadie der Technischen Chemie, Vol. 19 (1980), page 280 ff.

Particularly suitable graft polymers are also ABS polymers which are produced by persulphate initiation or by redox initiation with an initiator system made of organic hydroperoxide and ascorbic acid according to U.S. Pat. No. 4,937,285.

In the production of graft polymers of the ABS type according to the method of the invention, the grafting reaction is advantageously discontinued at a monomer conversion of 95% to 100%.

In a preferred embodiment, the content of unpolymerized vinyl aromatic component A) in the reaction mixture at any point in time is less than 12% by weight, preferably less than 10% by weight and particularly preferably less than 9% by weight.

To ensure that the content of unpolymerized vinyl aromatic component A) does not exceed said maximum values (or the content of another monomer is outside the desired range) these monomer concentrations are followed inline or online by means of Raman spectroscopy in a preferred embodiment of the invention. In the scope of the present invention online denotes a mode of operation in which part of the reaction mixture is branched off, for example, by a side loop from the reaction vessel, measured and then returned to the reaction mixture. Inline denotes that the measurement takes place directly in the reaction vessel.

For this purpose, Raman spectra of the reactor content are recorded at short time intervals during graft polymerization in the range of νₘᵢₙ=−4000 cm⁻¹ (anti-Stokes range) and νₘₐₓ=4000 cm⁻¹ (Stokes range), preferably νₘᵢₙ=500 cm⁻¹ and the νₘₐₓ=2,500 cm⁻¹, particularly preferably νₘᵢₙ=750 cm⁻¹ and νₘₐₓ=1,800 cm⁻¹. The frequency of the recorded measurements depends on speed of process data progress. Generally the recordings are taken at intervals of 1 second to 30 minutes, preferably 10 seconds to 10 minutes.

Any commercially available Raman spectrometer systems, preferably Fourier transformation and dispersive Raman spectrometers, are suitable for recording the spectra.

In a preferred embodiment, the observed monomer concentrations are calculated from the measured Raman spectra by the method of weighted subtraction as described below.

The factors fᵢ are calculated from the previously measured Raman spectra stored in digitized form in a data processing unit, I_{PB}(ν) of polybutadiene (PB), I_{PS}(ν) of polystyrene (PS), I_{PAN} (V) of polyacrylonitrile (PAN), I_{STY}(ν) of styrene (STY) and I_{ACN}(V) of acrylonitrile (ACN) and the actual spectrum I(ν) of the reactor content from the condition

νₘₐₓΣ{I_{K}(ν)−[f_{PB}*I_{PB}(ν)+f_{PS}*I_{PS}(ν)+f_{PAN}*I_{PAN}(ν)+f_{STY}*I_{STY}(ν)+f_{ACN}*I_{ACN}(ν)+fₖ]}²νₘᵢₙ=minimum

wherein summation is carried out via all data points of the spectra Iᵢ(ν) digitized in the same form.

From the factors fᵢ are calculated the quotients

Q_{PS}=f_{PS}/f_{PB}, Q_{PAN}=f_{PAN}/f_{PB}, Q_{STY}=f_{STY}/f_{PB} and Q_{ACN}=f_{ACN}/f_{PB}

and with the previously determined calibration factors K, the ratios W of:

polystyrene to polybutadiene: W_{PS}=K_{PS}*Q_{PS}

polyacrylonitrile to polybutadiene: W_{PAN}=K_{PAN}*Q_{PAN}

styrene to polybutadiene: K_{STY}*Q_{STY}

acrylonitrile to polybutadiene: W_{ACN}=K_{ACN}*Q_{ACN}

are calculated and therefrom according to:

M_{PS}=W_{PS}*M_{PB}, M_{PAN}=W_{PAN}*M_{PB}, M_{STY}=W_{STY}*M_{PB} and M_{ACN}=W_{ACN}*M_{PB}

the absolute quantities of polystyrene M_{PS}, polyacrylonitrile M_{PAN}, styrene M_{STY} and acrylonitrile M_{ACN} are determined in the reactor. The variable M_{PB} is constant during the reaction. The quantity of polybutadiene fed into the reactor is detected by means of conventional quantity measurement.

In a particularly preferred embodiment, the factors K_{PS}, K_{PAN}, K_{STY} and K_{ACN} are determined, in that the Raman spectra Iₖ(ν) are recorded from mixtures with known ratios. The factors fᵢ are calculated (weighted subtraction) from the condition

νₘₐₓΣ{I_{K}(ν)−[f_{PB}*I_{PB}(ν)+f_{PS}*I_{PS}(ν)+f_{PAN}*I_{PAN}(ν)+f_{STY}*I_{STY}(ν)+f_{ACN}*I_{ACN}(ν)+fₖ]}²νₘᵢₙ=minimum

the quotients

Q_{PS}=f_{PS}/f_{PB}, Q_{PAN}=f_{PAN}/f_{PB}, Q_{STY}=f_{STY}/f_{PB} and Q_{ACN}=f_{ACN}/f_{PB}

are determined therefrom, the weight parts W

ti W_{PS}=M_{PS}/M_{PB}, M_{PAN}=W_{PAN}/M_{PB}, W_{STY}=M_{STY}/M_{PB} and W_{ACN}=M_{ACN}/M_{PB}

are calculated from the known quantities M and the calibration factors K are calculated according to the equations

K_{PS}=W_{PS}/Q_{PS}, K_{PAN}=W_{PAN}/Q_{PAN}, K_{STY}=W_{STY}/Q_{STY} and K_{ACN}=W_{ACN}/Q_{ACN}.

The method according to the invention is distinguished by improved reaction reliability throughout the course of graft polymerization.

The graft polymers obtained by the method according to the invention are distinguished by very good mechanical properties (such as, for example, good impact strength) with very high reproducibility.

These graft polymers are suitable, preferably after mixing with at least one rubber-free resin component, for producing moldings, for example, domestic appliances, motor vehicle components, office machines, telephones, radio and television set housings, furniture, tubes, leisure articles or toys.

Copolymers of styrene and acrylonitrile with a weight ratio (styrene/acrylonitrile) of 95:5 to 50:50 are preferably used as rubber-free resin components, styrene and/or acrylonitrile being completely or partially replaceable by α-methyl styrene, methyl methacrylate or N-phenyl maleinimide. Particularly preferred are copolymers of which the contents of incorporated acrylonitrile units are below 30% by weight.

These copolymers preferably have weight average molecular weights M w of 20,000 to 200,000 and intrinsic viscosities [η] of 20 to 110 ml/g (measured in dimethyl formamide at 25° C.).

Details on producing these copolymers are, for example, described in DE-A 24 20 358 and DE-A 27 24 360 (U.S. Pat. Nos. 4,009,226 and 4,181,788 incorporated herein by reference). Vinyl resins produced by mass or solution polymerization have proved particularly expedient. The copolymers may be added alone or in any mixture.

Apart from thermoplastic resins made up of vinyl monomers the use of polycondensates, for example, aromatic polycarbonates, aromatic polyester carbonates, polyesters, polyamides as rubber-free resin components in the molding compounds according to the invention is also possible.

The invention will be illustrated hereinafter by examples, but without restriction to these examples.

### EXAMPLES

### Example 1

(According to the invention, simulation of an interruption in the initiator metering with continuous monitoring by recording Raman spectra and corrective-measures in the event of deviations from the desired behavior) 42 parts by weight of a monomer mixture of styrene and acrylonitrile (weight ratio 67.5:32.5) and 0.15 parts by weight tert.-dodecylmercaptan are metered within 6 h at 62° C. to 58 parts by weight (calculated as solids) of a polybutadiene latex (solids content about 30% by weight, median particle size (d₅₀) about 350 nm).

Simultaneously, 16.2 parts by weight of a 7.4% aqueous emulsifier solution (sodium salt of Desinate 731® from Abieta Chemie, Gersthofen, Germany) are added. The course of the reaction is continuously followed by recording Raman spectra. Once the Raman spectra showed an increase in monomeric styrene in the reaction mixture to above 8% by weight (based on polybutadiene), the monomer supply was stopped and 0.25 parts by weight potassium persulphate (in the form of 2.5% aqueous solution) added. After a drop in the monomeric styrene content in the reaction mixture to below 6% by weight (based on polybutadiene) the monomer metering is continued and a 3-hour metering of 0.25 parts by weight potassium sulphate started (in the form of a 2.5% aqueous solution).

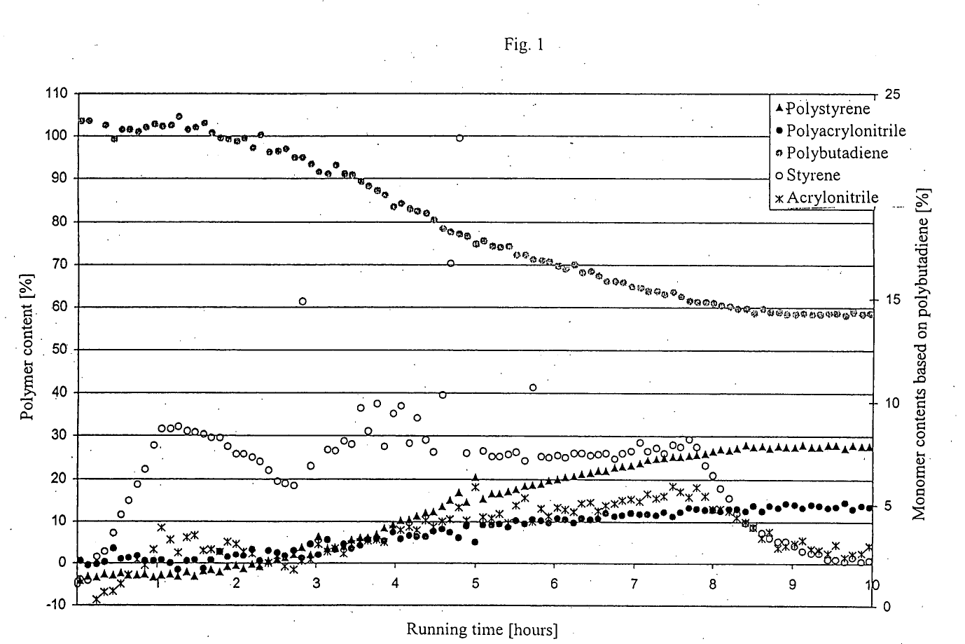

The total reaction time is 9 h (6 h reaction time+3 h post-stirring time at 70° C.), the course of the reaction (detected by Raman spectroscopy) is shown in FIG. 1.

### Example 2

(Comparative test, simulation of an interruption in the initiator metering without continuous monitoring by recording Raman spectra and without corrective measures in the event of deviations from the desired behavior).

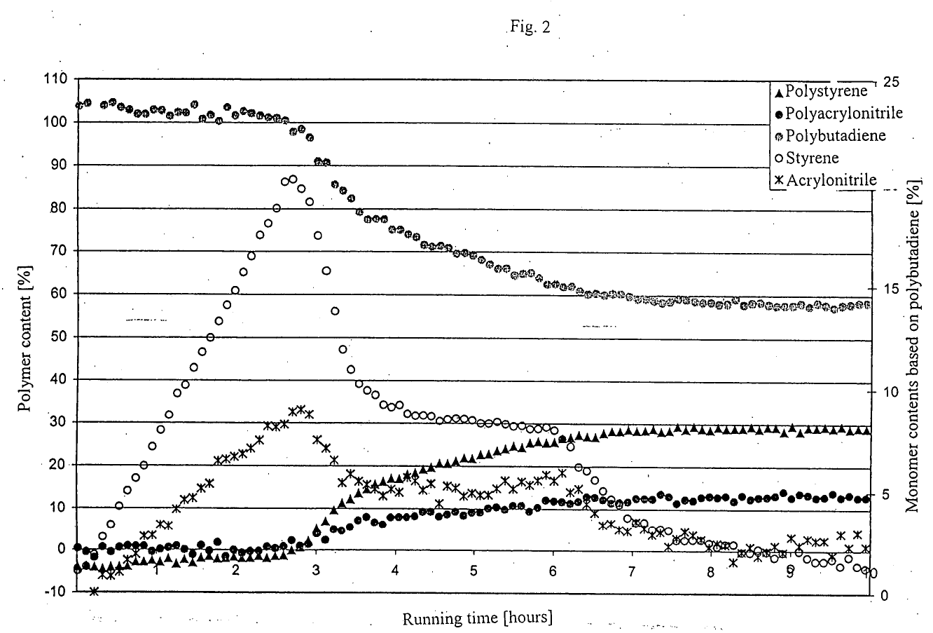

Example 1 is repeated, the increase in the monomeric styrene in the reaction mixture to 20% by weight (based on polybutadiene) taking place before polymerization is triggered by addition of potassium persulphate solution. The other reaction conditions remain unchanged. The course of the reaction (determined by Raman spectroscopy) is illustrated in FIG. 2.

### Example 3

(Comparative test, simulation of a course of the reaction without interruption in the initiator metering, reference test for desired course of the reaction). Example 1 is repeated, metering of the potassium persulphate solution taking place from the start simultaneously with the monomer metering. The other reaction conditions remain unchanged.

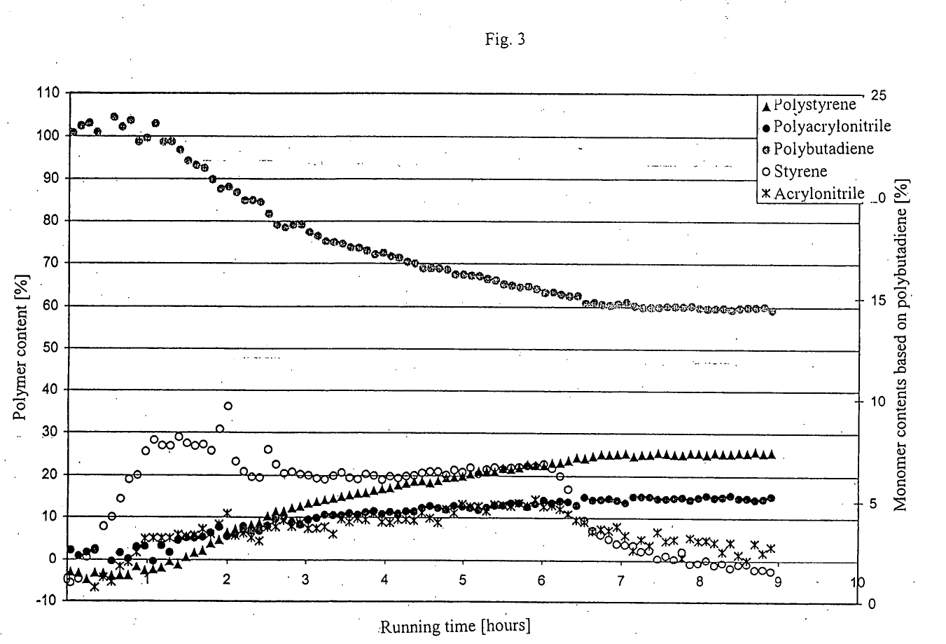

The course of the reaction (determined by Raman spectroscopy) is shown in FIG. 3.

Investigation and Checking of the Products from Examples 1 to 3

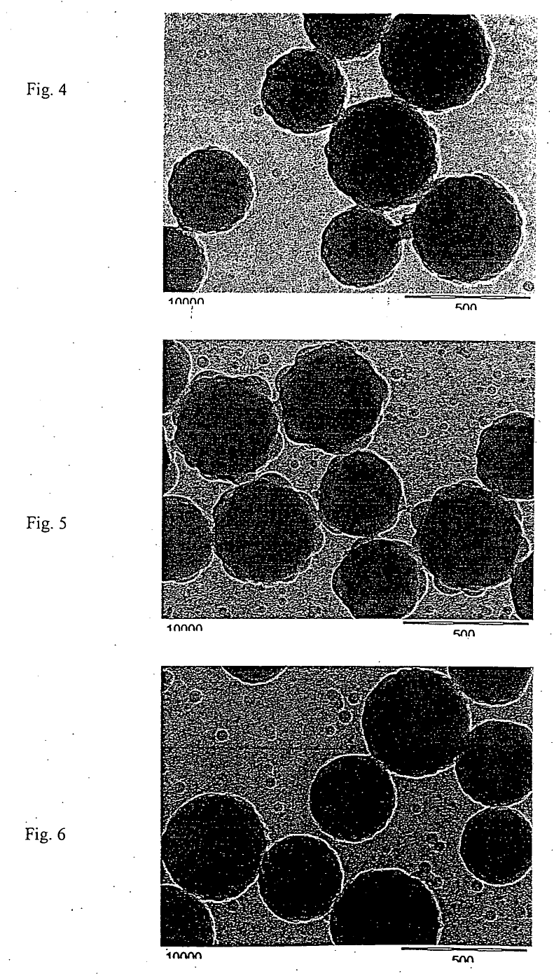

Latex samples are removed for characterization by electron microscope and measured after contrasting with osmium tetroxide. The morphologies shown in FIGS. 4, 5 and 6 show that a morphology is only obtained when monitoring the course of the reaction by Raman spectroscopy and carrying out corrective measures (FIG. 4, product from Example 1, uniform graft shell), which corresponds to that of the reference test (FIG. 6, product from Example 3). In the case of no monitoring and occurrence of faulty metering a product is produced with a non-uniform graft shell (FIG. 5, product from Example 2).

The graft rubber latexes resulting from Examples 1 to 3 were precipitated by addition of a phenolic antioxidant with a magnesium sulphate/acetic acid mixture in each case, whereupon the resultant graft powder was washed with water and dried in the drying chamber at 70° C.

Using this graft rubber powder, mixtures given in Table 1 were produced in an internal kneader and processed by injection molding to form test specimens. In the process, a product with a polybutadiene content of 50% by weight and a grafted-on styrene/acrylonitrile copolymer quantity of 50% by weight (styrene:acrylonitrile ratio 73:27) with a median particle diameter, d₅₀, of about 120 nm was used as the fine-particle graft rubber.

A product with a weight average molecular weight, M_{W}, of about 85,000 (styrene:acrylonitrile ratio 72:28) was used as SAN resin.

All the compositions contained 2 parts by weight ethylenediamine bisstearoylamide and 0.15 parts by weight of a silicone oil as additives.

Determination of the impact strength at ambient temperature (aₖ^{RT}, unit: kJ/m²) took place to ISO 180/1A, the thermoplastic pourability(MVI, unit: cm³/10 min) was determined to DIN 53 735 U.

The test values also given in Table 1 show that, product properties which are very similar to the reference material are obtained when using the graft rubber produced according to the invention.

TABLE 1
Compositions and test data on the molding compositions investigated

| Graft rubber from | Graft rubber from | Graft rubber from | Fine-particle graft | | | |
|---|---|---|---|---|---|---|
| Example 1 | Example 2 | Example 3 | rubber | SAN resin | aₖ^{RT} | MVR |
| [parts by weight] | [parts by weight] | [parts by weight] | [parts by weight] | [parts by weight | (kJ/m²) | (cm³/10 min) |
| 18 | — | — | 12 | 70 | 16.6 | 35.4 |
| — | 18 | — | 12 | 70 | 14.9 | 34.5 |
| — | — | 18 | 12 | 70 | 16.0 | 36.3 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. In the process for producing graft polymers of the ABS type by the emulsion method, wherein
5 to 95% by weight of a monomer mixture containing
A) 50 to 99% by weight of at least one vinyl aromatic compound
B) 1 to 50% by weight of at least one copolymer
are polymerised in the presence of
C) 95 to 5% by weight of one or more graft substrates with glass transition temperatures <10° C.,
the improvement comprising continuously monitoring the Raman spectra of the reaction mixture and introducing corrective measures if the concentration of one or more monomers deviates from its desired value.

2. The process according to claim 1, wherein the monomer concentrations are calculated from the Raman spectra by means of weighted subtraction.

3. The process according to claim 1, wherein the concentration of unpolymerised vinyl aromatic component A) in the reaction mixture is less than 12% by weight at any point in time.

4. The process according to claim 1, wherein the vinyl aromatic compound A) is styrene, the copolymer B) is acrylonitrile and the graft substrate C) is a polybutadiene rubber.

5. The process according to claim 1, wherein corrective measures are selected from increasing and decreasing the feed rate of at least one monomer or the initiator.
